(19) United States
(12) Patent Application Publication
(10) Pub. No.: US 2020/0104977 A1
(43) Pub. Date: Apr. 2, 2020

(54) Method of Adaptive Image Stitching and Image Processing Device

(71) Applicant: Augentix Inc., Hsinchu City (TW)

(72) Inventors: Po-Yen Su, Taipei City (TW); I-Chieh Hsieh, Hsinchu County (TW)

(21) Appl. No.: 16/147,868

(22) Filed: Sep. 30, 2018

(51) Int. Cl. G06T 3/40; G06T 7/20; G06T 5/00; G06T 5/20; G06T 3/00

(52) U.S. Cl. CPC G06T 3/4038; G06T 7/20; G06T 5/002; G06T 2207/20182; G06T 5/006; G06T 3/0068; G06T 5/20

(57) ABSTRACT

A method of adaptive image stitching for an image stitching device is disclosed. The method comprises receiving at least two images respectively captured by at least two cameras in different angle of views, from the at least two cameras, performing image motion estimation on an overlapping region of the two images, to obtain correspondence between two images with a plurality of motion vectors, wherein the plurality of motion vectors is used for indicating a geometry relation between the two images, performing dominant vector calculation according to the plurality of motion vectors of the image motion estimation, for obtaining a dominant motion vector in region of interest (ROI) of the overlapping region, and stitching the two images into a single seamless image with a stitching radius calculated according to the dominant motion vector.

### BACKGROUND OF THE INVENTION

### 1. Field of the Invention

The present disclosure relates to a method used in an image processing, and more particularly, to a method of adaptive image stitching and a related device.

### 2. Description of the Prior Art

In order to get wide field of view (FOV), fisheye camera is applied for 180° panoramic viewing. However, an image captured by the fisheye camera may have lower pixel utilization ratio in region of interest (ROI) and the objects in the outer area of the captured image may suffer severe distortion. Besides, fisheye camera is more expensive than cameras with normal lens (i.e. FOV is 120°).

In addition, image stitching operation is introduced for combining multiple images with overlapping fields of view captured from multiple cameras with normal lens, for getting wider FOV and higher resolution image. In detail, image stitching operation involves stitching radius calculated according to an object depth of the images. However, the applicant notices that conventional image stitching operation may result in ghost problem or unseen problem. Reference is made to FIG. 1, which illustrates a fixed stitching radius in an image processing system. In FIG. 1, the image processing system may include, not limited, two cameras with normal lens and an image stitching device (not shown) to execute image stitching operation/algorithm for images captured by the two cameras. The camera 1 captures image content A and B, and camera 2 captures image content B and C. With fixed stitching radius of the image stitching operation, an object far from the fixed stitching radius may suffer ghost issue (namely content B duplicate), whereas the object near than the fixed stitching radius may be unseen (namely content B missing).

As can be seen, conventional solutions for getting wide FOV have disadvantages, such as abovementioned ghost problem, unseen problem, lens distortion and parallax problem, which may reduce reliability of the image processing system.

### SUMMARY OF THE INVENTION

It is therefore an objective to provide a method of adaptive image stitching to solve the above problems.

The present disclosure provides a method of adaptive image stitching for an image stitching device. The method comprises receiving two images respectively captured by two cameras in different angle of views, from the two cameras, performing image motion estimation on an overlapping region of the two images, for obtaining correspondence between the two images with a plurality of motion vectors for indicating a geometry relation between the two images, performing dominant vector calculation according to the plurality of motion vectors of the image motion estimation, for obtaining a dominant motion vector in region of interest of the overlapping region, and stitching the two images into a single seamless image with a stitching radius calculated according to the dominant motion vector.

The present disclosure provides an image stitching device for adaptive image stitching. The image stitching device comprises an image receiving module, for receiving two images respectively captured by two cameras in different angle of views, from the two cameras, a correspondence matching module, coupled to the image receiving module, for obtaining correspondence between two images with a plurality of motion vectors for indicating a geometry relation between the two images in an overlapping region, a dominant vector calculating module, coupled to the correspondence matching module, for calculating a dominant motion vector in region of interest (ROI) of the overlapping region according to the plurality of motion vectors, and a stitching module, coupled to the dominant vector calculating module, for stitching the two images into a single seamless image with a stitching radius calculated according to the dominant motion vector.

The present disclosure provides an image processing system for adaptive image stitching. The image processing system comprises a plurality of cameras, for capturing images in different angle of views, and an image stitching device, connecting to the cameras for performing an image stitching operation, wherein the image stitching device includes a processing means for executing a program, and a storage unit coupled to the processing means for storing the program, wherein the program instructs the processing means to perform the following steps receiving two images respectively captured by two cameras in different angle of views, from the two cameras, performing image motion estimation on an overlapping region of the two images, to obtain correspondence between two images with a plurality of motion vectors for indicating a geometry relation between the two images, performing dominant vector calculation according to the plurality of motion vectors of the image motion estimation, for obtaining a dominant motion vector in region of interest (ROI) of the overlapping region, and stitching the two images into a single seamless image with a stitching radius calculated according to the dominant motion vector.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an image processing system according to the prior art.

FIG. 2 is a schematic diagram of an image processing system according to one embodiment of the present disclosure.

FIG. 3 is a schematic diagram of an image stitching device according to one embodiment of the present disclosure.

FIG. 4 is a flowchart according to an embodiment of the present disclosure.

FIGS. 5-8 are schematic diagrams of image stitching operation according to embodiments of the present disclosure.

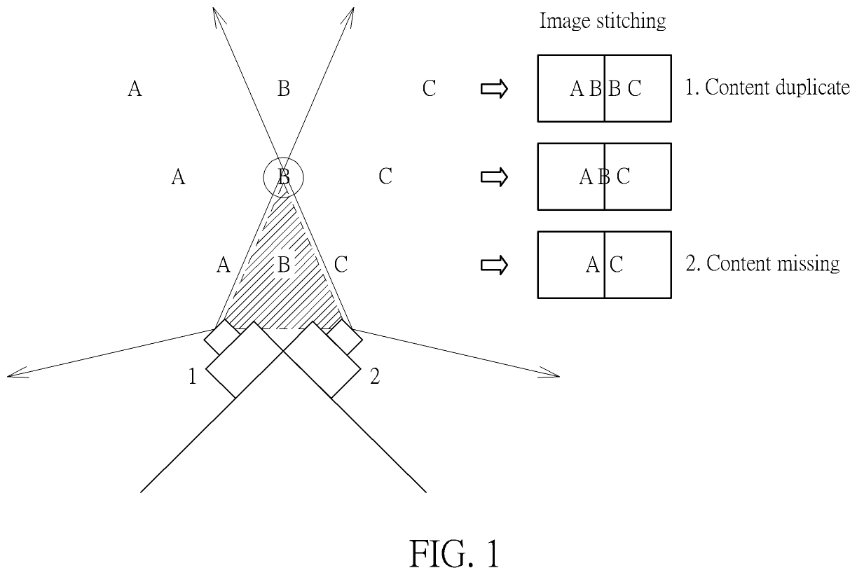

### DETAILED DESCRIPTION

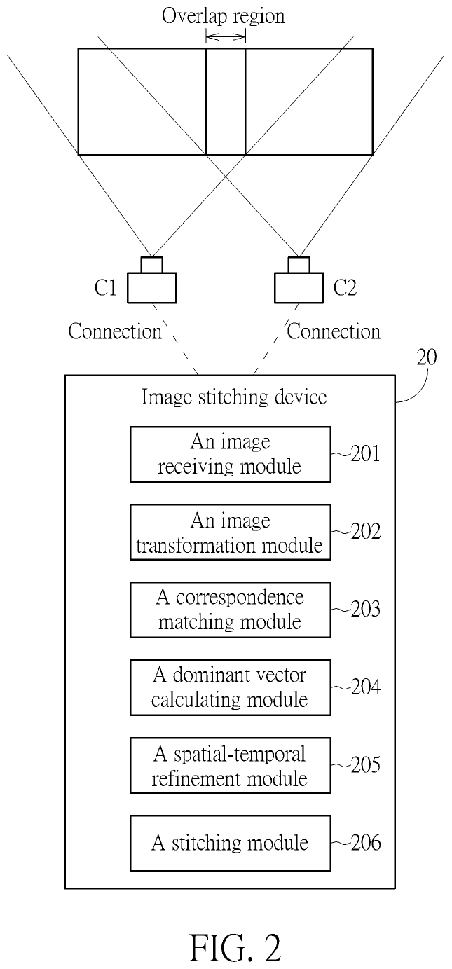

Please refer to FIG. 2, which is a schematic diagram of an image processing system according to one embodiment of the present disclosure. The image processing system includes multiple cameras C1 and C2 and an image stitching device 20. Note that, FIG. 2 is simply utilized for illustrating the structure of the image processing system, where the number of cameras and the lens type (e.g. fisheye lens or normal lens) of the cameras are not limited herein. The cameras C1 and C2 may be arranged at different angle of views, but shall be coordinated to capture images in some overlap. The image stitching device 20 is utilized to implement image stitching operation/algorithm, and includes an image receiving module 201, an image transformation module 202, a correspondence matching module 203, a dominant vector calculating module 204, a spatial-temporal refinement module 205 and a stitching module 206. In a word, the image receiving module 201 is used for receiving images from the cameras C1 and C2. The image transformation module 202 is used for image alignment for the received images. The correspondence matching module 203 is used for obtaining correspondence between the received images in an overlapping region. The dominant vector calculating module 204 is used for obtaining a dominant motion vector in region of interest (ROI) of the overlapping region of the received images. The spatial-temporal refinement module 205 is used for dynamically updating the dominant motion vector, to generate a smooth image stitching result with updated dominant motion vector. The stitching module 206 is used for stitching the received images into a single seamless image with a stitching radius, which is calculated according to the updated dominant motion vector.

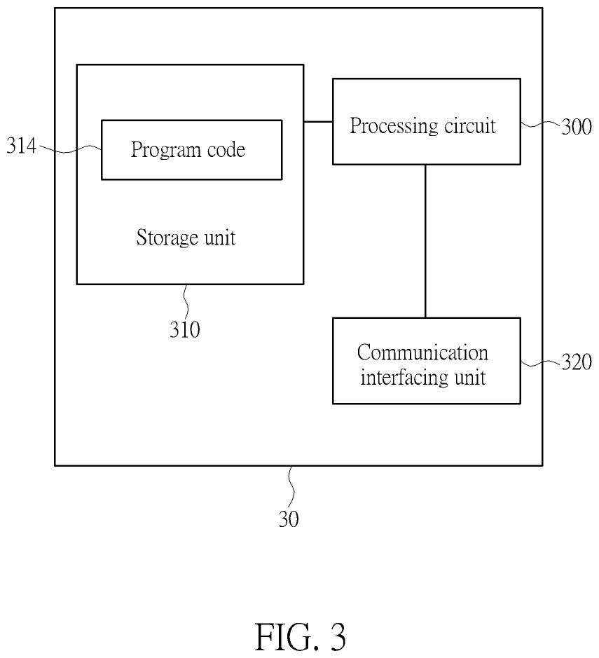

FIG. 3 is a schematic diagram of an image stitching device according to one embodiment of the present disclosure. The image stitching device 30 may include, not limited, a processing unit 300, such as a microprocessor or Application Specific Integrated Circuit (ASIC), a storage unit 310 and a communication interfacing unit 320. The storage unit 310 may be any data storage device that can store a program code 314, for access by the processing unit 300. Examples of the storage unit 310 include but are not limited to a subscriber identity module (SIM), read-only memory (ROM), flash memory, random-access memory (RAM), CD-ROMs, magnetic tape, hard disk, and optical data storage device. The communication interfacing unit 320 can be the image receiving module 201 of FIG. 2 and is applied with a wire or wireless communication for exchange signals/data with the cameras C1 and C2 of FIG. 2.

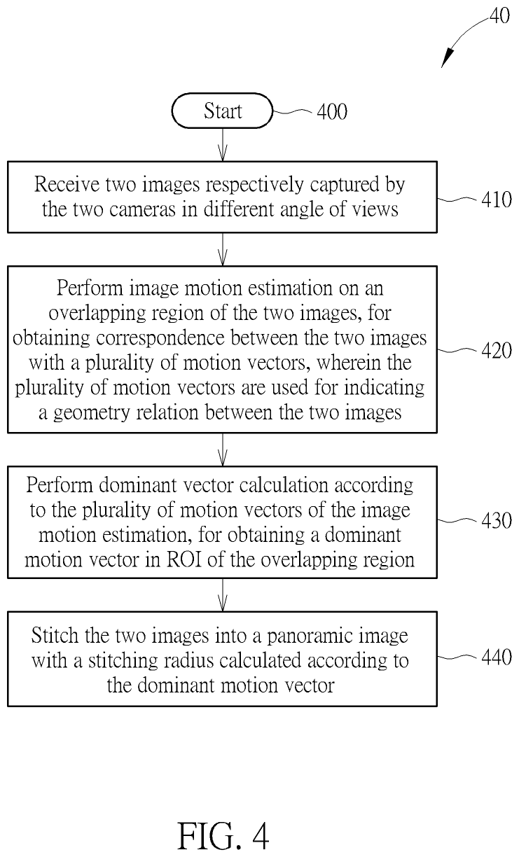

Please refer to FIG. 4, the image stitching operation of the image stitching device 30 can be summarized as a process 40. The process 40 may be compiled into a program code 314 to be stored in the storage unit 310. As shown in FIG. 4, the process 40 includes following steps:

Step 410: Receive two images respectively captured by the two cameras in different angle of views.

Step 420: Perform image motion estimation on an overlapping region of the two images, for obtaining correspondence between the two images with a plurality of motion vectors, wherein the plurality of motion vectors are used for indicating a geometry relation between the two images.

Step 430: Perform dominant vector calculation according to the plurality of motion vectors of the image motion estimation, for obtaining a dominant motion vector in ROI of the overlapping region.

Step 440: Stitch the two images into a panoramic image with a stitching radius calculated according to the dominant motion vector.

According to the process 40, the cameras C1 and C2 of the image processing system performs image acquisition to obtain images with overlap, and then transmits the images to the image stitching device 20 for image stitching operation. On the other hand, the image stitching device 20 performs image motion estimation on the overlapping region of the two images, to obtain motion vectors (e.g. horizontal or vertical translations), and then performs dominant vector calculation according to the obtained motion vectors, for extracting the most dominant motion vector in ROI of the overlapping region, so as to increase the reliability of the correspondence between the images. Finally, the image stitching device 20 stitches the images with the stitching radius in accordance with the most dominant motion vector, so as to generate a panoramic image.

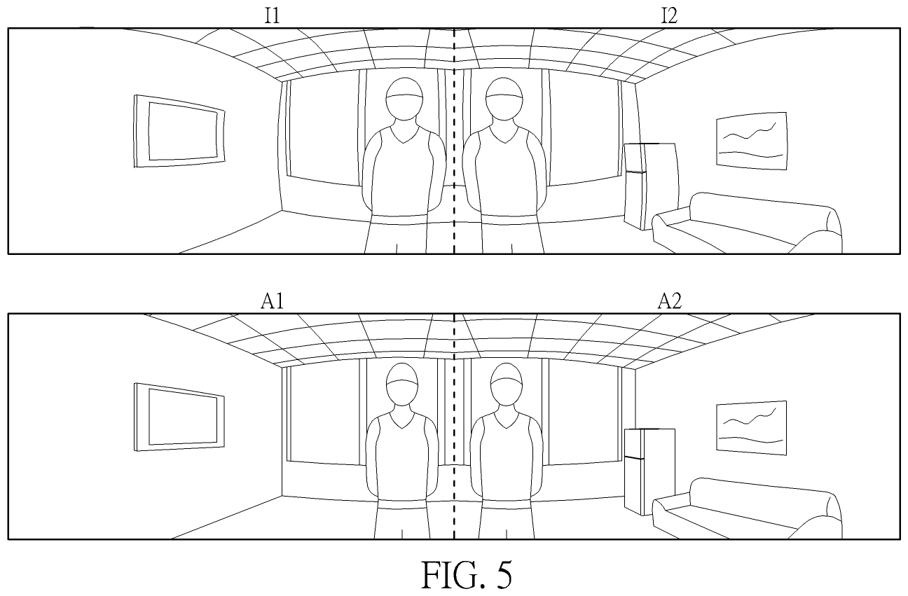

Reference is made to FIGS. 5-8, which illustrates detailed operation of the image stitching device 20. In an embodiment, the image stitching device 20 alternatively performs an image registration or an image transformation for aligning the received images. That is, the image stitching device 20 may perform a lens distortion correction, a de-warping or a geometry transformation on the received images, to rearrange position of pixels of the images, for image alignment. As shown in FIG. 5, the images I1 and I2 are de-warped for rotation correction and translation correction, so as to output aligned images A1 and A2. Note that, image transformation is an optional operation, depending on the camera lens and structure of the multi-camera set.

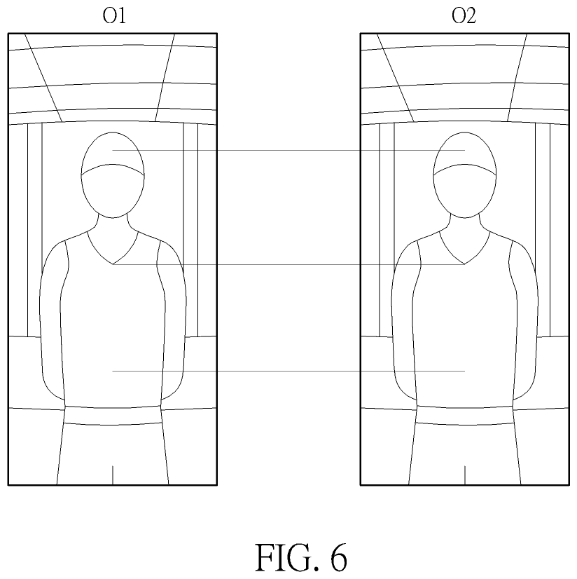

In addition, referring to FIG. 6, the overlapping regions O1 and O2 of the aligned images A1 and A2 is cropped for image motion estimation. The image motion estimation may be a content correspondence matching operation, an optical flow operation, a patch-based matching operation or a feature-based matching operation. In an embodiment, the image motion estimation is the optical flow operation. Note that, the optical flow operation is not applicable for a specific feature points of the images A1 and A2, but for all the pixels of the overlapping regions O1 and O2 of the images A1 and A2, to get optical flow vectors for every pixel of the overlapping regions O1 and O2 of the images A1 and A2. Therefore, sufficient information (e.g. optical flow vectors) for processing image stitching is obtained.

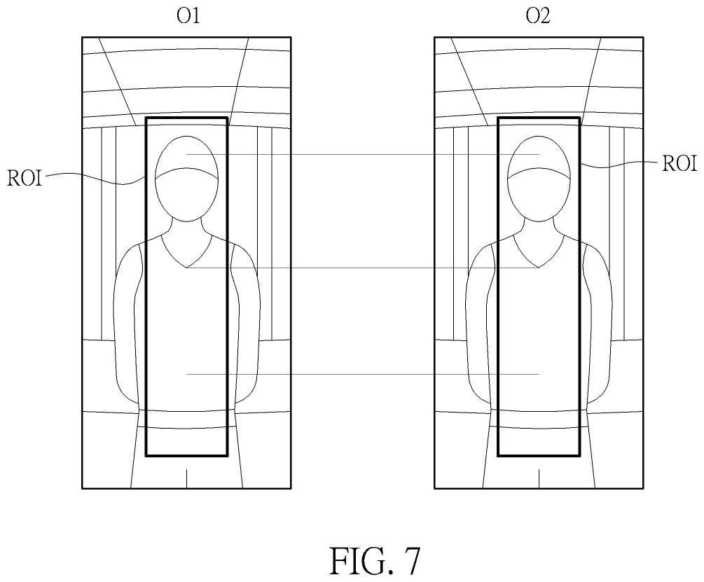

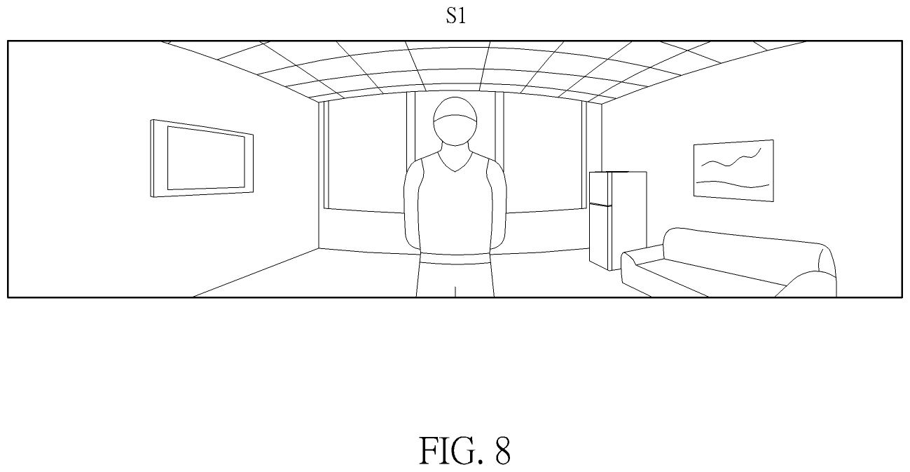

After obtaining the optical flow vectors, as shown in FIG. 7, the image stitching device 20 performs the dominant vector calculation in ROI of the overlapping regions O1 and O2, to extract the most dominant flow vector from the obtained optical flow vectors. The dominant flow vector has the highest reliability for calculating a stitching radius, so as to stitch the images A1 and A2 with the stitching radius. Finally, the stitched image O1 is outputted, which is seen as a panoramic camera shot, as shown in FIG. 8.

For enhancement of image stitching quality, the image stitching device 20 may perform a spatial-temporal refinement to update the dominant flow vector in a time domain. In other words, the dominant flow vector is optimized with consideration of visual continuity for the user. In detail, the spatial-temporal refinement provides functionality of predicting at stitching direction/speed change, smoothing and denoising on the stitching radius while stitching the images A1 and A2, for getting adaptive dominant flow vector. Consequently, stitching radius is dynamically changed according to the dominant flow vector, so as to realize image stitching operation in real-time.

The abovementioned steps of the processes/operations including suggested steps can be realized by means that could be a hardware, a firmware known as a combination of a hardware device and computer instructions and data that reside as read-only software on the hardware device or an electronic system. Examples of hardware can include analog, digital and mixed circuits known as microcircuit, microchip, or silicon chip. Examples of the electronic system can include a system on chip (SOC), system in package (SiP), a computer on module (COM) and the image stitching device 20.

In conclusion, the present invention provides an image stitching operation, which is able to get an accurate stitching radius for stitching images, so as to avoid unseen and ghost problems. In addition, with adaptive stitching radius of the present invention, a real-time image stitching operation is implemented.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of adaptive image stitching for an image stitching device, the method comprises:
receiving at least two images respectively captured by at least two cameras in different angle of views, from the at least two cameras;
performing image motion estimation on an overlapping region of the two images, for obtaining correspondence between the two images with a plurality of motion vectors, wherein the plurality of motion vectors are used for indicating a geometry relation between the two images;
performing dominant vector calculation according to the multiple motion vectors of the image motion estimation, to obtain a dominant motion vector in region of interest (ROI) of the overlapping region; and
stitching the two images into a single seamless image according to a stitching radius calculated according to the dominant motion vector.

2. The method of claim 1, further comprising:
performing a spatial-temporal refinement for dynamically updating the dominant motion vector, to generate a smooth image stitching result with updated dominant motion vector for the stitching radius.

3. The method of claim 1, further comprising:
performing a lens distortion correction operation, a de-warping operation or a geometry transformation operation on the images of the cameras.

4. The method of claim 1, wherein the motion vectors include horizontal and vertical translation parameters.

5. The method of claim 1, wherein the image motion estimation includes content correspondence matching operation, optical flow operation, patch-based matching operation and feature-based matching operation.

6. An image stitching device for adaptive image stitching, the image stitching device comprising:
an image receiving module, for receiving at least two images respectively captured by at least two cameras in different angle of views, from the at least two cameras;
a correspondence matching module, coupled to the image receiving module, for obtaining correspondence between the two images with a plurality of motion vectors, wherein the plurality of motion vectors is used for indicating a geometry relation between the two images in an overlapping region;
a dominant vector calculating module, coupled to the correspondence matching module, for obtaining a dominant motion vector in region of interest (ROI) of the overlapping region according to the plurality of motion vectors; and
a stitching module, coupled to the dominant vector calculating module, for stitching the two images into a single seamless image with a stitching radius calculated according to the dominant motion vector.

7. The image stitching device of claim 6, further comprising:
a spatial-temporal refinement module for dynamically updating the dominant motion vector, to generate a smooth image stitching result with updated dominant motion vector for the stitching radius.

8. The image stitching device of claim 6, further comprising:
an image transformation module for rearranging position of pixels of the two images, for image alignment of the two images by a lens distortion correction operation, a de-warping operation or a geometry transformation operation performed on the received images.

9. The image stitching device of claim 6, wherein the motion vectors include horizontal and vertical translation parameters.

10. The image stitching device of claim 6, wherein the correspondence matching module is further used for performing an image motion estimation on the overlapping region of the two images.

11. The image stitching device of claim 10, wherein the image motion estimation includes content correspondence matching operation, optical flow operation, patch-based matching operation and feature-based matching operation.

12. An image processing system for adaptive image stitching, the image processing system comprising:
at least two cameras, for capturing images in different angle of views;
an image stitching device, connecting to the at least two cameras, for performing an image stitching operation;
wherein the image stitching device includes:
a processing means for executing a program; and
a storage unit coupled to the processing means for storing the program; wherein the program instructs the processing means to perform the following steps:
receiving at least two images respectively captured by the at least two cameras in different angle of views, from the at least two cameras;
performing image motion estimation on an overlapping region of the two images, for obtaining correspondence between two images with a plurality of motion vectors, wherein the plurality of motion vectors is used for indicating a geometry relation between the two images;
performing dominant vector calculation according to the plurality of motion vectors of the image motion estimation, for obtaining a dominant motion vector in region of interest (ROI) of the overlapping region; and
stitching the two images into a single seamless image with a stitching radius calculated according to the dominant motion vector.

13. The image processing system of claim 12, wherein the program further instructs the processing means to perform the following steps:
performing a spatial-temporal refinement for dynamically updating the dominant motion vector, to generate a smooth image stitching result with updated dominant motion vector for the stitching radius.

14. The image processing system of claim 12, wherein the program further instructs the processing means to perform the following steps:
performing a lens distortion correction operation, a de-warping operation or a geometry transformation operation on the images of the cameras, to rearrange position of pixels of the images, for image alignment of the two images.
